(19) United States
(12) Patent Application Publication
(10) Pub. No.: US 2009/0242538 A1
(43) Pub. Date: Oct. 1, 2009

(54) DECORATIVE TRIM HEATING DEVICE

(76) Inventors: DENNIS PORZIO, Florence, SC (US); Craig Knight, Bennettville, SC (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/055,892

(22) Filed: Mar. 26, 2008

(51) Int. Cl. H05B 1/00

(52) U.S. Cl. 219/213; 392/436; 219/522; 29/611

(57) ABSTRACT

A decorative trim heating device includes a heater and a decorative cover. The cover further includes a wall-side surface and a front-side surface, the wall-side surface defining a channel within which the heater is disposed and the front side surface defining a decorative pattern. The decorative trim heater also includes fasteners to secure the heater to the cover and fasteners to secure the heater and the cover to a surface in a room.

### FIELD OF THE INVENTION

The present invention relates generally to a method and apparatus for heating a room. More particularly, the present invention relates to a decorative trim heating device.

### BACKGROUND OF THE INVENTION

Electric radiant heaters have been used for some time to provide heat in homes, offices and other spaces. A heating element inside the heater, often in the form of an electrical resistor, converts electrical energy to heat energy. The heat produced by the heating element travels through air or space until it hits a surface. This heat directly warms people and objects in the room, rather than warming the air. Electric radiant heaters are often installed as baseboard heaters along a wall near the floor, or in other convenient locations around a room. However, these heaters are not designed to coordinate with the décor of the room, in which they are installed. Therefore, the heater often stands out, as opposed to blending in unnoticed.

### SUMMARY OF THE INVENTION

The foregoing disadvantages are overcome, to a great extent, by the present invention, wherein in one aspect, an apparatus is provided that in some embodiments provides a decorative heating device for placement against a surface in a room that includes a heater and a cover having a wall-side surface and a front-side surface, the wall-side surface defines a channel within which the heater is disposed and the front side surface defines a decorative pattern. The invention may also include fasteners to secure the heater to the cover and fasteners to secure the heater and the cover to a surface in a room.

In accordance with an aspect of the present invention, the cover may take the form of any one of crown molding, a chair rail, a baseboard, a window sill, door trim, window trim, or other form. The cover may include vents that enable heat generated by the heater to pass therethrough and can be formed from plastic, wood, or other suitable material. Additionally, the heater may extend substantially through an entire length of the cover. The decorative heater may take the form of any one of a low wattage electric radiant heater, a low wattage resistive heater, or any other suitable heater.

In accordance with another aspect of the present invention, a method of manufacturing a decorative heating device for a room includes providing a heater, configuring a decorative cover for the heater, such that the decorative cover resembles decorative trim for placement in a room, and housing the heater within the decorative cover. The method may also include providing a fastening mechanism configured to fasten the decorative cover to the heater and providing a surface securing device configured to secure the decorative cover to a surface in the room.

In accordance with yet another aspect of the present invention, the method can also include manufacturing the decorative cover so that it resembles any one of crown molding, a baseboard, a chair rail, a window sill, door trim, window trim, or other form. The method may include manufacturing the decorative cover from wood, plastic, or other suitable material and manufacturing the decorative cover with vents to define a flow path for heat generated by the heater. The method may also include a heater taking the form of a low wattage electric radiant heater, a low wattage resistive heater, or any other suitable form of heater.

In accordance with still another aspect of the present invention, a decorative heating device for placement against a surface in a room includes means for generating heat and means for housing the means for generating heat. The decorative heating device may also include means for fastening the means for generating heat to the means for housing and means for fastening the means for housing to a surface in a room. The means for housing may include any one of crown molding, a chair rail, a baseboard, a window sill, door trim, window trim, or other form and may be made from plastic, wood, or other suitable material. The means for housing may also include a means that enables heat generated by the heater to pass therethrough, and the means for generating heat may extend substantially through an entire length of the means for housing. The means for generating heat may take the form of a low wattage electric radiant heater, a low wattage resistive heater, or any other suitable form of heater.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a decorative trim radiant heating device in accordance with an embodiment of the present invention.

FIG. 2 is a perspective view illustrating a decorative trim radiant heating device in accordance with another embodiment of the present invention.

FIG. 3 is a perspective view illustrating the decorative trim heating device in accordance with an embodiment of the present invention.

FIG. 4 is a back view illustrating the decorative trim heating device in accordance with an embodiment of the present invention.

FIG. 5 illustrates the decorative trim heating devices installed in a room in accordance with an embodiment of the present invention.

FIG. 6 is a flow chart illustrating a method of manufacture of the decorative trim heating device in accordance with an embodiment of the present invention.

### DETAILED DESCRIPTION

The invention will now be described with reference to the drawing figures, in which like reference numerals refer to like parts throughout. An embodiment in accordance with the present invention provides an apparatus and a method for providing decorative electric radiant heat to a room or other space.

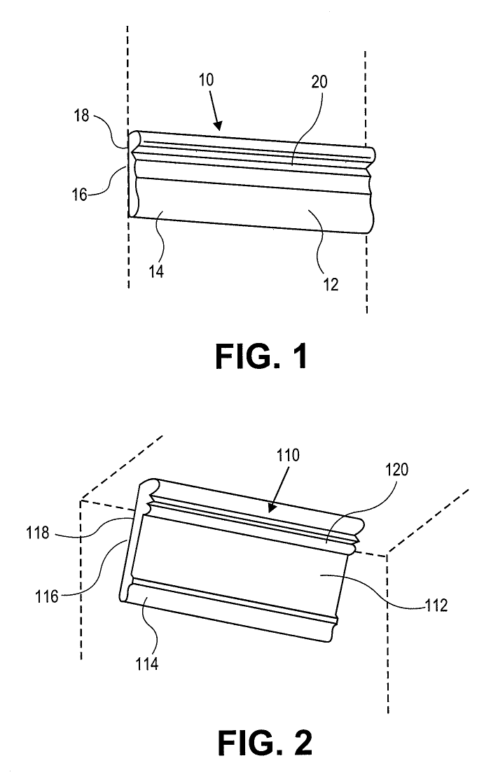

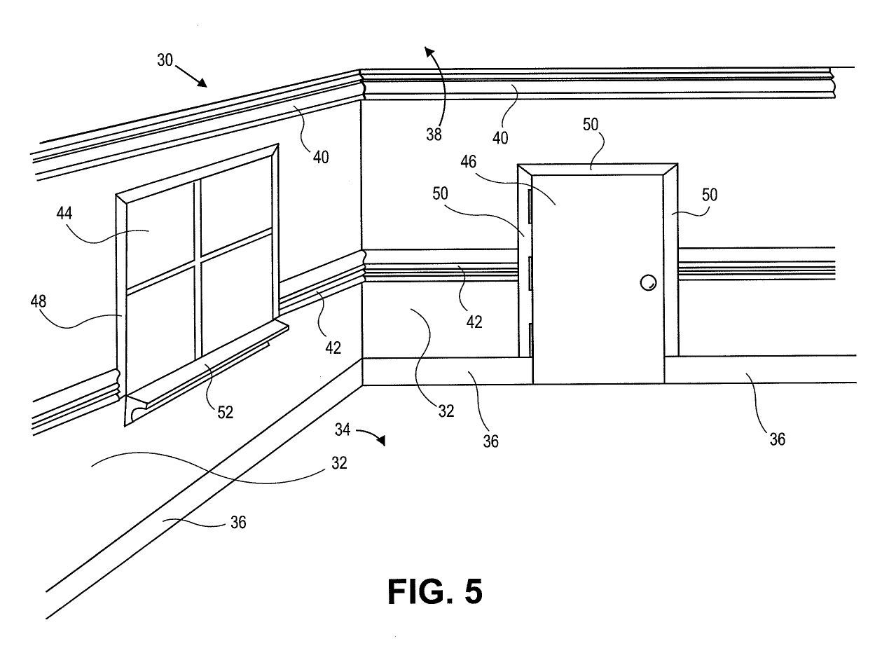

FIGS. 1 and 2 are perspective views illustrating a decorative trim heating device 10 in accordance with an embodiment of the invention. FIG. 1 illustrates a cover9. The cover 12 may be mounted over a heating element to provide a uniform appearance with the decorative trim used throughout a room. The cover 12 may be configured to be mounted against a flat surface such as a wall, and may be used as a chair rail, window door trim, a baseboard, or other form, as illustrated in more detail in FIG. 5. A front side surface 14 of the cover 12 may be beveled or otherwise decorated to resemble other trim used in the room. A back side surface 16 of the cover 12 defines a channel 18 within which the heating element may be disposed. The cover 12 may be formed from plastic, wood, or any other suitable material that transfers heat from the heating element.

FIG. 2 illustrates a cover 112 to be mounted over a heating element to provide a uniform appearance with decorative trim used in a room. The cover 112 may be configured to be mounted at a joint between a wall and a ceiling or as a part of a window sill as illustrated in more detail in FIG. 5. A front side surface 114 of the cover 112 can be beveled or otherwise decorated to resemble other trim used in the room. A back side surface 116 of the cover 112 defines a space or channel 118 within which the heating element may be disposed.

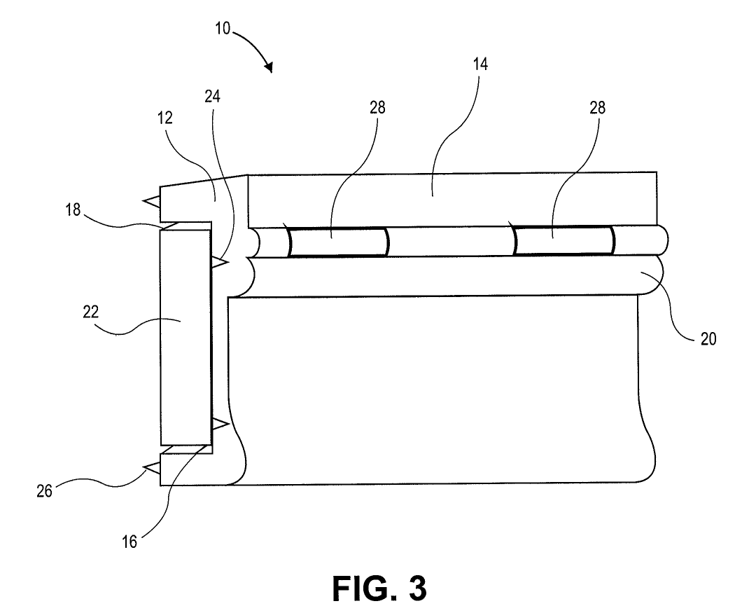

FIG. 3 is a perspective view illustrating the decorative trim heating device 10 in accordance with an embodiment of the present invention. The decorative trim heating device 10 includes the cover 12 that has the front-side surface 14 and the wall-side surface 16. The front-side surface 14 defines a decorative pattern 20. The decorative pattern 20 may be beveling, carving, artwork, designs, paintings, or any other decoration that coordinates with the décor of the room. The wall-side surface 16 defines a channel 18, within which a heater 22 is disposed. According to one embodiment, the heater 22 may include a low wattage electric radiant heating element a resistive heating element, or other suitable heating element. The heater 22 may be used in conjunction with the cover 12 to create the decorative trim heating device 10, and heater 22 may extend substantially through an entire length of the cover 12. Fasteners 24 secure the heater 22 to the cover 12. A second set of fasteners 26 may secure the heater 22 and the cover 12 to a surface in the room, such as a wall. Additionally, vents 28 in the cover 12 allow the heat generated by the heater 22 to pass therethrough. The vents 28 may be incorporated into the cover 12 in such a way that they become a part of the decorative pattern 20 of the cover 12.

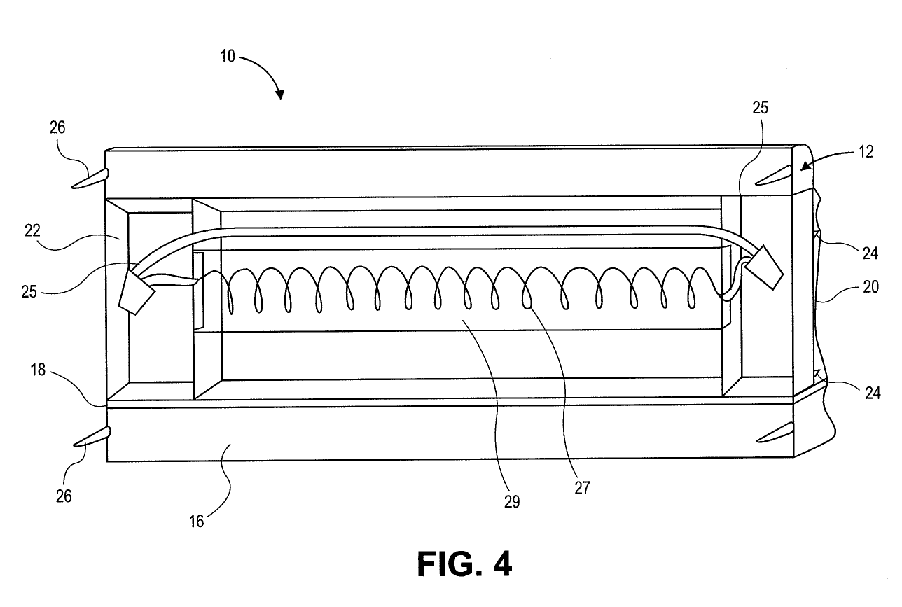

FIG. 4 is a rear view of the decorative trim heating device 10 in accordance with an embodiment of the present invention. The heating device 10 includes the heater 22. The heater 22 is disposed in the channel 18 defined by the wall side surface 16 of the decorative cover 12 and extending through the length of the cover 12. The heater 22 has a power supply 25 located at each end of the heater 22. A heating element 27 is disposed within a heating element channel 29 and extends the length of the heater 22. The heating element 27 may be, for example, a low wattage electric radiant heating element, a resistive heating element, or other suitable heating element. Fasteners 24 secure the heater 22 to the decorative cover 12 and fasteners 26 secure the decorative cover 12 and the heater 22 to a wall.

FIG. 5 illustrates the decorative trim heating device 10 installed in a room 30 in accordance with one embodiment of the invention. FIG. 5 illustrates the exemplary placements of the decorative trim heating device 10 in the room 30. The decorative trim heating device 10 may be placed on a wall 32 near a floor 34 and used as a baseboard 36. The decorative trim heating device 10 may also be placed on the wall 32 near a ceiling 38 and used as crown molding 40 or may be placed near the middle of the wall 32 and used as a chair rail 42. If the decorative trim heating device 10 is used as the baseboard 36, crown molding 40, or chair rail 42, it may replace portions of baseboard, crown molding or chair rail already used in the room or it can be used exclusively as the baseboard, crown molding or chair rail. The decorative trim heating device 10 may also be mounted on the wall 32 around a window 44 or a door 46 and used as window trim 48 or door trim 50. If the decorative trim heating device 10 is used as window trim 48 or door trim 50, it may be used exclusively or may replace portions of the existing window trim 48 or door trim 50. Additionally, the decorative trim heating device 10 may be mounted on a wall below the window 44 and used as a window sill 52.

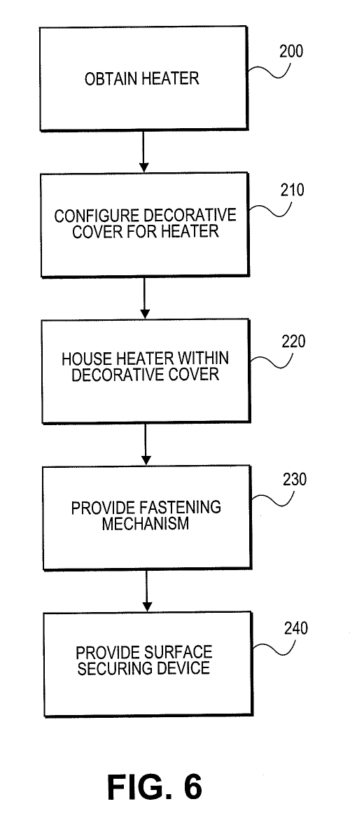

FIG. 6 is a flow chart illustrating a method of manufacturing a decorative trim heating device in accordance with one embodiment of the invention. The method includes a step 200 of obtaining a heater. Any suitable heater may be used to create the decorative trim heating device. Another step 210 includes configuring a decorative cover for the heater, such that the decorative cover resembles decorative trim for placement in a room. The cover may be manufactured from wood, plastic or any other material that conducts heat and may also include vents to define a flow path for the heat generated by the heater. The cover may be manufactured to resemble crown molding, a baseboard, a chair rail, a window sill, door trim, or window trim. Step 220 includes housing the heater within the decorative cover, and step 230 includes providing a fastening mechanism configured to fasten the decorative cover to the heater. Another step 240 includes providing a surface securing device configured to secure the decorative cover to a surface in the room.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A decorative heating device for placement against a surface in a room comprising:
a heater;
a cover including a wall-side surface and a front-side surface, the wall-side surface defining a channel within which the heater is disposed and the front side surface defining a decorative pattern;
fasteners to secure the heater to the cover; and
fasteners to secure the heater and the cover to a surface in a room.

2. The decorative heating device of claim 1, wherein the cover comprises any one of crown molding, a chair rail, a baseboard, a window sill, door trim and window trim.

3. The decorative heating device of claim 1, wherein the cover comprises vents that enable heat generated by the heater to pass therethrough.

4. The decorative heating device of claim 1, wherein the cover comprises any one of plastic and wood.

5. The decorative heating device of claim 1, wherein the heater comprises any one of a low wattage electric radiant heater and a low wattage resistive heater.

6. The decorative heating device of claim 1, wherein the heater extends substantially through an entire length of the cover.

7. The decorative heating device of claim 1, wherein the cover comprises any one of beveling, carving, designs, or painting.

8. A method of manufacturing a decorative heating device for a room comprising:
providing a heater;
configuring a decorative cover for the heater, such that the decorative cover resembles decorative trim for placement in a room;
housing the heater within the decorative cover;
providing a fastening mechanism configured to fasten the decorative cover to the heater;
providing a surface securing device configured to secure the decorative cover to a surface in the room.

9. The method of claim 8, wherein the decorative cover resembles any one of crown molding, a baseboard, a chair rail, a window sill, door trim, and window trim.

10. The method of claim 8, further comprising manufacturing the decorative cover from any one of wood and plastic.

11. The method of claim 8, wherein the heater comprises any one of a low wattage electric radiant heater and a low wattage resistive heater.

12. The method of claim 8, further comprising providing the decorative cover with vents to define a flow path for heat generated by the heater.

13. The method of claim 8, wherein the decorative cover comprises any one of beveling, carving, designs, or painting.

14. A decorative heating device for placement against a surface in a room comprising:
means for generating heat;
means for housing the means for generating heat;
means for fastening the means for generating heat to the means for housing;
means for fastening the means for housing to a surface in a room.

15. The decorative heating device of claim 14, wherein the means for housing comprises any one of crown molding, a chair rail, a baseboard, a window sill, door trim and window trim.

16. The decorative heating device of claim 14, wherein the means for housing comprises any one of plastic and wood.

17. The decorative heating device of claim 14, wherein the heater comprises any one of low wattage electric radiant heater and a low wattage resistive heater.

18. The decorative heating device of claim 14, wherein the means for housing comprises a means that enables heat generated by the heater to pass therethrough.

19. The decorative heating device of claim 14, wherein the means for generating heat extends substantially through an entire length of the means for housing.

20. The decorative heating device of claim 14, wherein the means for housing comprises any one of beveling, carving, designs, or painting.
